(19) United States
(12) Patent Application Publication
(10) Pub. No.: US 2015/0046993 A1
(43) Pub. Date: Feb. 12, 2015

(54) PASSWORD AUTHENTICATION METHOD AND SYSTEM

(71) Applicant: Leo Arceo, Las Pinas City (PH)

(72) Inventor: Leo Arceo, Las Pinas City (PH)

(21) Appl. No.: 13/961,790

(22) Filed: Aug. 7, 2013

(51) Int. Cl. H04L 29/06

(52) U.S. Cl. CPC H04L 63/0838
USPC 726/7

(57) ABSTRACT

A computing system comprising a memory for storing a user list, character configuration options, algorithm options, and a user registration system; and a processor coupled to the memory and configured to execute the user registration system; wherein the user registration system is configured to receive a login request from a user, look up the user in the user list to identify a selected character configuration and a selected password algorithm. The processor is further configured to randomly generate system characters based on the selected character configuration; transmit the system characters to the user for display based on the selected character configuration; generate a system password based on the system characters and the selected password algorithm. The user is granted access to the computing system when the system password and a user password are the same.

### FIELD OF THE INVENTION

The present invention relates to a new password authentication method and system.

### BACKGROUND

The basic authentication scheme in use today requires a user ID and a password. This authentication scheme is used to protect networks, software systems and even personal computers on boot up. With the advent of the automated, brute force approach to guessing passwords, there is an awareness campaign to educate users to change their passwords regularly and to create strong passwords to protect their access. The costs to support this awareness campaign and to reset passwords of the users who forget their constantly changing passwords are increasing every year.

However, static passwords are vulnerable to hacking and to being cracked. Normally the static passwords are encrypted using a method such as MD5. Crackers normally encrypt a standard dictionary using the same algorithm to initiate the cracking method. Encrypting the words in a dictionary will produce an encrypted string. After this, a brute force approach is normally taken by running specialized software on graphics cards. Multiple graphics processing unit (GPUs) can be linked together to create a super computing platform. This platform then runs through several billion combinations to produce a match with the target password list. This encrypted string is compared to the target password list. If the strings match it means that the original dictionary word was the password. All it takes is time.

To address this, schemes have been developed to give the user a One-Time Password (OTP) i.e. a password that is valid for only one login session. OTPs are advantageous over static passwords by the fact that they are not vulnerable to replay attacks. This means that a potential intruder who manages to record an OTP that was already used to log into a service will be unable to abuse it, as it will no longer be valid. On the downside, OTPs are difficult for human beings to memorize. Therefore they normally require additional technology, like security tokens in order to work. An example of such a case is that banks provide security tokens to their users who will use these security tokens to generate the OTPs. PassWindow is another one such scheme that works by providing a user with a plastic card (security token) that has a key pattern. At the login screen, the system generates and displays a challenge pattern to the user. The user then superimposes the key pattern over the challenge pattern to reveal a composite pattern which acts as a OTP as the challenge pattern varies.

The disadvantage with such schemes is that the user will need the security token with him every time he logins to the system. This can be inconvenient and troublesome. There is therefore a need for a new method to generate an OTP without requiring additional hardware or devices like security tokens.

### SUMMARY OF INVENTION

According to a first aspect of the present invention, a computing system is described, the computing system comprising memory for storing a user list, character configuration options, algorithm options, and a user registration system; and at least one processor coupled to the memory and configured to execute the user registration system. The user registration system is configured to receive a login request from a user, the login request including a user ID; look up the user in the user list to identify a selected character configuration from the character configuration options associated with the user ID and a selected password algorithm from the algorithm options associated with the user ID. The user registration system is further configured to randomly generate at least one system character based on the selected character configuration; transmit the at least one system character to the user for display based on the selected character configuration; generate a system password based on the at least one system character and the selected password algorithm; receive a user password from the user; compare the system password and the user password; and grant the user access to the computing system when the system password and the user password are the same.

Preferably, the user registration system is further configured to generate and display at least one hoax character, wherein the at least one hoax character is not used in generating the system password.

Preferably, the selected character configuration determines the positions the system characters will occupy when being displayed

Preferably, the selected character configuration determines the sequence of appearance of the system characters.

Preferably, the selected password algorithm is selected from a group consisting of a mathematical equation and a string of characters.

Preferably, the at least one system character comprises one or more characters selected from a group consisting of alphabetic, numeric, alphanumeric, symbol, and punctuation characters.

According to a second aspect of the present invention, a password authentication method for determining if access is to be granted to a computer system at a login stage is described, the method comprising the steps of accepting a user name at a login screen; associating the user name with a selected algorithm and a selected character configuration, the algorithm and the character configuration having been selected prior to the login stage. The method further comprises the steps of randomly generating at least one system character based on the selected character configuration; displaying the at least one system character according to the selected character configuration and computing a system password by using the selected algorithm and the at least one system character. The method further comprises the steps of accepting a user entry; comparing the user entry with the system password and granting access when the user entry is identical to the system password.

Preferably, the method further comprises the steps of randomly generating at least one hoax character and displaying the at least one hoax character, wherein the at least one hoax character is not used to compute the system password.

Preferably, the selected character configuration determines the positions the system characters will occupy when being displayed.

Preferably, the selected character configuration determines the sequence of appearance of the system characters.

Preferably, the selected algorithm is selected from a group consisting of a mathematical equation and a string of characters.

Preferably, the system character comprises one or more characters selected from a group consisting of alphabetic, numeric, alphanumeric, symbol and punctuation characters.

The invention will now be described in detail with reference to the accompanying drawings.

### BRIEF DESCRIPTION OF THE DRAWINGS

The accompanying figures illustrate disclosed embodiment(s) and serve to explain principles of the disclosed embodiment(s). It is to be understood, however, that these drawings are presented for purposes of illustration only, and not for defining limits of the application.

FIG. 1 shows a flowchart of the User Registration Process according to some embodiments.

FIGS. 2A and 2B show a flowchart of the User Login Process according to some embodiments.

FIG. 3 shows a block diagram of a user registration system according to some embodiments.

FIG. 4 shows a computing system according to some embodiments.

Exemplary, non-limiting embodiments of the present application will now be described with references to the above-mentioned figures.

### DETAILED DESCRIPTION

The invention disclosed is a computer system that, employs a password authentication method which uses a dynamic system password for authentication. The system password acts as an OTP for each different login attempt. The system password for each login attempt is generated by passing system characters generated for that login attempt through a user-preselected algorithm. In other words, the system password for a login attempt is dependent on the system characters generated for that login attempt. As the generated system characters are random, and will be different for each successive login attempt, therefore, the system passwords of successive login attempts will also be different.

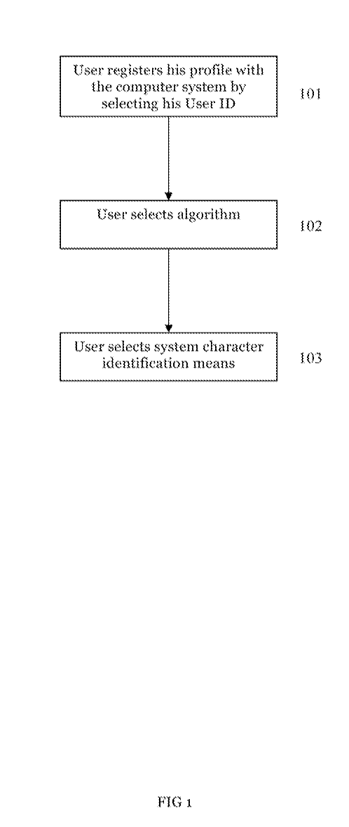

FIG. 1 shows a flowchart of the User Registration Process according to some embodiments. In step 101, a user registers his profile or account with the computer system. The computer system can comprise any number and combination of processing units. Examples of processing units are computer machines, terminals, workstations, servers and the like. In this document, any reference to computer system can refer to any one of the processing units of the computer system.

The user can use a processing unit of the computer system to perform the User Registration Process. The user will have to select his User ID. This User ID is important as it uniquely identifies the user in the computer system. The user will also be prompted by the computer system to supplement the profile or account with his personal details like name, email addresses, etc.

As part of the User Registration Process, the computer system provides various algorithms for the user to choose from. These algorithms are used to compute the system password, i.e., the password to access the computer system. These algorithms can be a mathematical equation or a string of characters. The characters can be alphabetic, numeric, alphanumeric, symbols, punctuations, and the like.

These algorithms are a function of system characters. System characters are characters randomly generated by the computer system, and can be alphabetic, numeric, alphanumeric, symbols, punctuations, and the like. For example, an algorithm can be the mathematical equation “2x+y+1”, and x and y are the system characters. x and y can be numeric characters like “12” and “5”.

In another example, an algorithm can be the string of characters “My first pet is a x and its name is y”, and x and y are the system characters. x and y can be alphabetic characters like “dog” and “Lassie”. In another example, an algorithm can be the string of characters “x HelloWorld y”, and x and y are the system characters. x and y can be characters that contain symbols and punctuations like “@!” and “#?”.

There is no limit to the number of system characters that can be present in an algorithm. One skilled in the art will appreciate that the more system characters in an algorithm, the more secure the system password would be as the system password would have more possible permutations. However, more system characters would generally translate to a more complicated algorithm for the user to remember. There is therefore a trade-off between level of security and how complicated the algorithm should be.

In step 102, the user chooses one of the algorithms as provided by the computer system.

In step 103, the user selects the system character identification means as provided by the computer system. The purpose of the system character identification means is so that during a login attempt, the user will be able to identify which characters displayed on the login screen are the system characters. It is important that the user must be clear on how to distinguish which are the system characters. If it is not clear to the user which are the system characters, the user may end up using a hoax character instead (hoax characters will be explained in more detail later in this document) which will result in the user computing a wrong password.

Further, if the algorithm has more than one system character, the system character identification means will allow the user to distinguish between the system characters. If however, the computer system does not intend to display any hoax characters, and the algorithm chosen only has one system character, then there will be no need for the user to select the system character identification means.

In an embodiment, the system character identification means is done by the user selecting the system character configuration. The system character configuration is the positions or locations the system characters will occupy on the login screen. In other words, the system character configuration specifies the pixels in which the system characters will be displayed on in the login screen. For example, the login screen may be partitioned to a three by three matrix, whereby 1A, 2A, 3A, 1B, 2B, 3B, 1C, 2C and 3C denote the positions on the login screen like so:—

$$[ \begin{matrix}1 A & 1 B & 1 C \\ 2 A & 2 B & 2 C \\ 3 A & 3 B & 3 C\end{matrix} ]$$

The number of positions a user has to select will be dependent on the number of system characters in an algorithm. If the user selected the mathematical equation “2x+y+1” as the algorithm, the user would then have to select two positions, one position for system character x and one position for system character y. The user can select position 1A for system character x and position 3B for system character y

$$[ \begin{matrix}x & 1 B & 1 C \\ 2 A & 2 B & 2 C \\ 3 A & y & 3 C\end{matrix} ]$$

One skilled in the art will be able to appreciate that there are variations to the system character configuration. The system character configuration may not just determine the positions or locations the system characters will occupy on the login screen, but can also determine the sequence of appearance of the system characters. For example, the first and fourth characters to be displayed by the computer system would be the system characters and the other characters would therefore be hoax characters.

At the completion of the registration process, the algorithm and the system character identification means that the user has selected will be associated with the user's User ID.

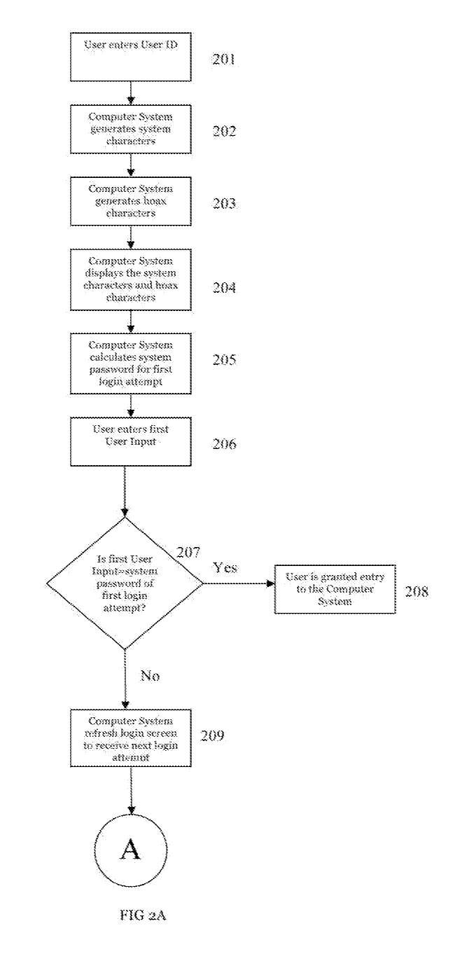

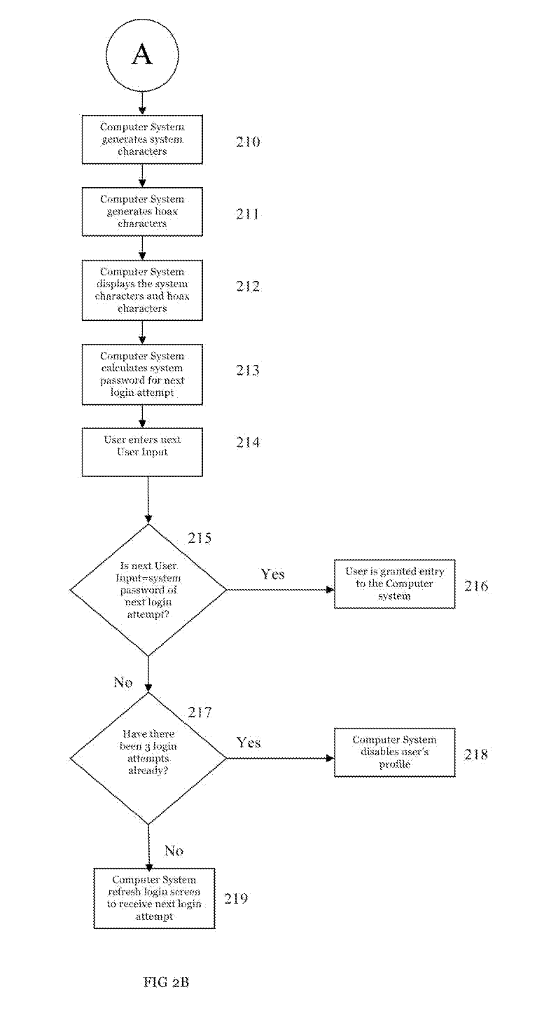

FIGS. 2A and 2B show a flowchart of the User Login Process according to some embodiments. In step 201, the user enters his User ID at the login screen of a processing unit of the computer system. The computer system then retrieves the user's profile, in particular, the selected algorithm and system character identification means. For illustration purposes, the selected algorithm is 2x+y+1, the selected system character identification means is by system character configuration, and position 1A is selected for system character x and position 3B is selected for system character y

$$[ \begin{matrix}x & 1 B & 1 C \\ 2 A & 2 B & 2 C \\ 3 A & y & 3 C\end{matrix} ]$$

In step 202, the computer system randomly generates the system characters. In this illustration, for the first login attempt, system character x is generated as “12” and system character y is generated as “5”:—

$$[ \begin{matrix}12 & 1 B & 1 C \\ 2 A & 2 B & 2 C \\ 3 A & 5 & 3 C\end{matrix} ]$$

In step 203, the computer system generates hoax characters. Hoax characters are not used by the algorithm when computing the system password. Hoax characters are simply used to confuse any hacker or intruder, as the hacker or intruder may think that the hoax characters are part of, or play a part in the computation of the system password. This therefore adds an additional layer of complication to any password cracking attempt. Hoax characters themselves are randomly generated and the number of hoax characters generated in each login attempt may differ.

In this illustration, the computer system generates three hoax characters “60”, “61” and “62”. Preferably, if the algorithm is a mathematical equation, the hoax values will all be numerical characters.

In step 204, the computer system displays the system characters and the hoax characters on the login screen. The system characters are displayed in the positions according to the system character configuration. The hoax characters can be displayed in all positions except those that were previously selected by the user for the system characters to occupy. One can thus appreciate how important a role specifying the system characters configuration plays as it allows the user to differentiate which characters displayed to him are the system characters and which are the hoax characters.

In this illustration, the system displays the three hoax characters “60”, “61” and “62” in positions 3A, 2B and 1C respectively:—

$$[ \begin{matrix}12 & 1 B & 62 \\ 2 A & 61 & 2 C \\ 60 & 5 & 3 C\end{matrix} ]$$

In step 205, the computer system calculates the system password for the first login attempt by passing in the system characters generated for the first login attempt (system character x=“12” and system character y=“5”) into the algorithm “2x+y+1”. The system password for the first login attempt is therefore 30.

In step 206, the user enters his first User Input. To compute the first User Input, the user would have to recall the algorithm and the system character configuration he selected during the User Registration Process; identify on the login screen which characters are the system characters via the system character configuration, and pass the system characters into the algorithm.

In step 207, if first User Input equals to the system password of the first login attempt (30), the first login attempt is successful and in step 208 the user will be granted entry into the computer system.

If however the first User Input is not equal to the system password of the first login attempt (30), the user will be denied entry to the computer system and in step 209, the computer system will refresh the login screen to receive a second or next login attempt. In step 210, the computer system randomly generates the system characters for the second login attempt. In this illustration, the system character x is generated as “10” and system character y is generated as “15”:—

$$[ \begin{matrix}10 & 1 B & 1 C \\ 2 A & 2 B & 2 C \\ 3 A & 15 & 3 C\end{matrix} ]$$

In step 211, the computer system generates the hoax characters. In this illustration, the computer system generates two hoax characters “25” and “26”.

In step 212, the computer system displays the system characters and the hoax characters on the login screen. The system characters are displayed in the positions according to the system character configuration and in this illustration, the computer system displays the two hoax characters “25” and “26” in positions 3A and 2B respectively:—

$$[ \begin{matrix}10 & 1 B & 1 C \\ 2 A & 26 & 2 C \\ 25 & 15 & 3 C\end{matrix} ]$$

In step 213, the computer system calculates the system password for the second login attempt by passing in the generated system characters (system character x=“10” and system character y=“15”) into the algorithm “2x+y+1”. The system password for the second login attempt is therefore 36.

In step 214, the user enters his second User Input. To compute the second User Input, the user would have to recall the algorithm and the system character configuration he selected during the User Registration Process; identify on the login screen which characters are the system characters via the system character configuration, and pass the system characters into the algorithm.

In step 215, if the second User Input equals to the system password of the second login attempt (36), the second login attempt is successful and in step 216, the user will be granted entry into the computer system.

If however the second User Input is not equal to the system password of the second login attempt (36), the user will be denied entry into the computer system. In step 219, the computer system will refresh the login screen to receive a third login attempt. The computer system then randomly generates the system characters for the third login attempt. In this illustration, the system character x is generated as “88” and system character y is generated as “200”.

The computer system then randomly generates the hoax characters. In this illustration, three hoax characters “10”, “20” and “30” are generated.

The computer system then displays the system characters and the hoax characters on the login screen. The system characters are displayed in the positions according to the system character configuration and in this illustration, the computer system displays the three hoax characters “10”, “20” and “30” in positions 2A, 1B and 2C respectively:—

$$[ \begin{matrix}88 & 20 & 1 C \\ 10 & 2 B & 30 \\ 3 A & 200 & 3 C\end{matrix} ]$$

The computer system then calculates the system password for the third login attempt by passing in the generated system characters (system character x=“88” and system character y=“200”) into the algorithm “2x+y+1”. The system password for the third login attempt is therefore 377.

The user then proceeds to enter his third User Input. To compute the third User Input, the user would have to recall the algorithm and the system character configuration he selected during the User Registration Process; identify on the login screen which characters are the system characters via the system character configuration, and pass the system characters into the algorithm.

If the third User Input equals to the system password of the third login attempt (377), the third login attempt is successful and the user will be granted entry into the computer system.

If however the third User Input is not equal to the system password of the third login attempt (377), the user will be denied entry to the computer system. In step 217, the computer system checks if there have already been three login attempts by this user. If so, in step 218, the computer system disables the user's profile. Although the flow chart shows disabling the user's profile after three failed login attempts, the number of failed login attempts before disabling the user's profile may be any positive number. In some examples, the positive number may be configurable.

An illustration of the invention when the algorithm is a string of characters is now shown. In this illustration, the algorithm chosen is “x HelloWorld y” and the selected system character identification means is by system character configuration, and position 1A is selected for system character x and position 3B is selected for system character y

$$[ \begin{matrix}x & 1 B & 1 C \\ 2 A & 2 B & 2 C \\ 3 A & y & 3 C\end{matrix} ]$$

For the first login attempt, the computer system generates system character x as “@!” and system character y as “#?”. The computer system then generates four hoax characters “!1a”, “@2b”, “#3c” and “$4d”. Preferably, if the algorithm is a string of characters, the hoax values will contain alphabetic, numeric, alphanumeric, symbols, and/or punctuations characters.

The computer system then displays the system characters and the hoax characters on the login screen. The system characters are displayed in the positions according to the system character configuration and in this illustration, the computer system displays the four hoax characters “!1a”, “@2b”, “#3c” and “$4d” in positions 2A, 3A, 2C and 3C respectively:—

$$[ \begin{matrix}@ ! & 1 B & 1 C \\ ! 1 a & 2 B & \#3 c \\ @ 2 b & \# ? & \$4 d\end{matrix} ]$$

The computer system then calculates the system password for the first login attempt by passing in the generated system characters (system character x=“@!” and system character y as “#?”) into the algorithm “x HelloWorld y”. The system password for the first login attempt is therefore “@!HelloWorld#?”.

The user enters his first User Input. If first User Input equals to the system password of the first login attempt (@!HelloWorld#?), the first login attempt is successful and the user will be granted entry into the computer system.

If however the first User Input is not equal to the system password of the first login attempt (@!HelloWorld#?), the user will be denied entry to the computer system and the computer system will refresh the login screen to receive a second or next login attempt. The mechanics of the subsequent login attempts are similar to the previous illustration.

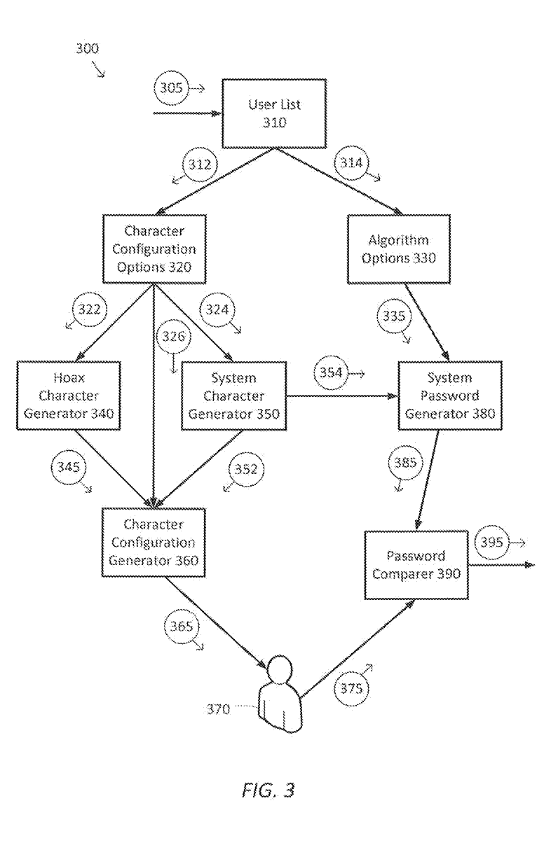

FIG. 3 shows a block diagram of a user registration system 300 according to some embodiments. As shown in FIG. 3, a user ID 305, such as the user ID entered by the user during process 201, is used to look up the profile of a corresponding user in a user list 310. User list 310 may be any kind of list, data structure, database, and/or the like suitable for recording user profiles and supporting a look up by user ID. Based on the user ID 305 and the user profile, a selected character configuration identifier 312 is used to identify one or more character configuration parameters from a set of character configuration options 320. Similarly, based on the user ID 305 and the user profile, a selected algorithm identifier 314 is used to identify a selected password algorithm 335 from a set of algorithm options 330. The selected password algorithm 335 is passed to a system password generator 380. Character configuration options 320 and algorithm options 330 may be stored in any kind of list, data structure, database, and/or the like suitable for recording the sets of options.

The character configuration parameters are passed to a hoax character generator 340 as hoax character parameters 322 and to a system character generator 350 as system character parameters 324. The hoax character parameters 322 are used by hoax character generator 340 to generate one or more hoax characters 345 using process 203 or something similar. The system character parameters 324 are used by system character generator 350 to generate one or more system characters 352 using process 202 or something similar. The one or more system characters 352 are also passed to system password generator 380 as system characters 354. A selected character configuration 326 is also sent to a character configuration generator 360.

The hoax characters 345 and the system characters 352 are passed to character configuration generator 360. Using the selected character configuration 326, the hoax characters 345, and the system characters 352, character configuration generator 360 generates a character configuration 365 to be sent to and displayed to a user 370 associated with the user ID 305 using process 204 or something similar.

Based on the character configuration 365 and selected password algorithm 335 as remembered by user 370, user 370 enters a password 375 using process 206 or something similar. The entered password 375 is sent to a password comparer 390. Password comparer 390 also receives a system password 385 from a system password generator 380. System password 385 is generated by system password generator 380 based on the system characters 354 and the selected password algorithm 335 using process 205 or something similar. Password comparer 390 then compares system password 385 and the entered password 375 using process 207, or something similar, to generate a signal 395 to determine whether user 370 is successfully logged in.

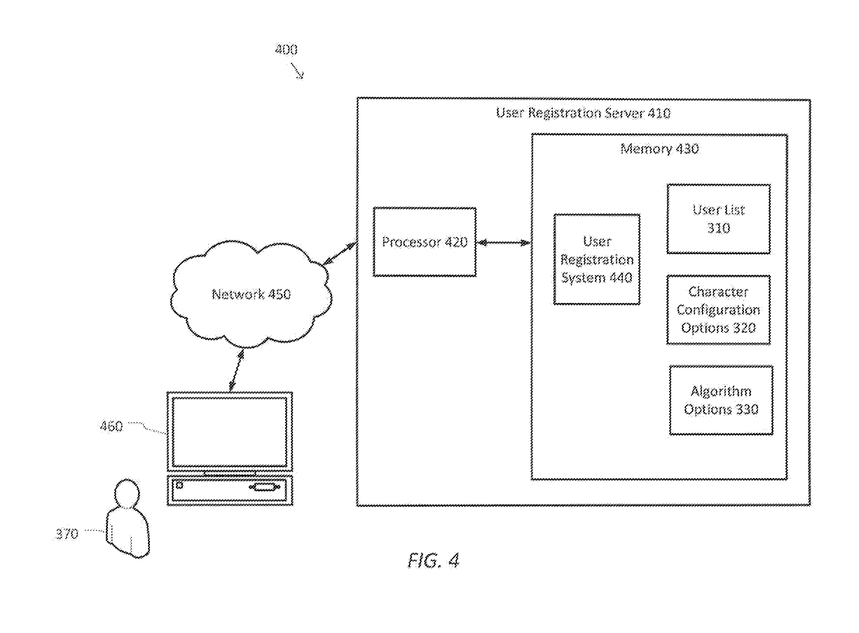

FIG. 4 shows a computing system 400 according to some embodiments. As shown in FIG. 4, computing system 400 illustrates a representative example of how a user registration system, like user registration system 300 may be implemented. Computing system 400 includes a user registration server 410. In some examples, user registration server 210 may be a computer machine, a terminal, a workstation, a server, and/or the like. User registration server 410 includes a processor 420 coupled to memory 430. In some examples, processor 420 may control operation and/or execution of hardware and/or software on user registration server 410. Although only one processor 420 is shown, user registration server 410 may include multiple processors. Memory 430 may include one or more types of machine readable media. Some common forms of machine readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Memory 430 may be used to store a user registration system 440. In some examples, user registration system 440 may be consistent with user registration system 300. Memory 430 may also be used to store user list 310, character configuration options 320, and/or algorithm options 330.

User registration server 410 may be coupled to a network 450. Network 450 may be any kind of network including a local area network (LAN), such as an Ethernet, and/or a wide area network (WAN), such as the internet. Also coupled to network 450 is a user computer 460 for use by user 370. User computer 460 may be any kind of computing device capable of connecting user 370 to user registration server 410 including a terminal, a workstation, a laptop, a tablet, a mobile phone, and/or the like.

Some examples of user registration system 300 and/or 420 may include non-transient, tangible, machine readable media that include executable code that when run by one or more processors (e.g., processor 420) may cause the one or more processors to perform the processes of the methods of FIGS. 1, 2A, and/or 2B as described above. Some common forms of machine readable media that may include the processes of the methods of FIGS. 1, 2A, and/or 2B are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

One skilled in the art can thus appreciate that the system password is dynamic. This is because for each successive login attempt, the system password will be different, in essence acting as an OTP. The strength of this authentication scheme against a brute force approach to guessing the system password is that each guess at a password would have to consider the system values. Which means a password cracker cannot just run several billion combinations. It has to wait for the system values before it can attempt a guess at the password. Since a password cracking program is iterative and tries all possible combinations it will have to do so for each combination of system values which increases the level of security. Therefore, these traditional tools that rely on billions of password combinations per second become useless or at the very least, very ineffective.

Another advantage of the invention is that there is no need for any additional hardware or devices like security tokens to implement the OTP. All the user needs to do is recall the algorithm and the system character identification means he selected during the User Registration Process, and identify and pass the system characters that are displayed to him on the login screen, into the algorithm to compute the system password for that login attempt or OTP. This negates the hassle of requiring the security token every time you login. Security tokens themselves cost money, are susceptible to damage and wear, and will have to be replaced. The dissemination of security tokens to the users is also at a cost to service providers like banks. The invention overcomes all these disadvantages and provides a cheaper and more convenient way to implement OTPs.

The computer system can comprise of any combination of processing units (for example, computer machines, terminals, workstations, servers over a secured network). Each processing unit can comprise the necessary processing power, storage media, display devices, graphic interfaces to:—
provide a plurality of system character identification means for selection by a user;
provide a plurality of algorithms for selection by a user;
accept a user name at a login screen;
randomly generate at least one system character;
associate the user name with the selected system character identification means and display the at least one system character according to the selected system character identification means;
associate the user name with the selected algorithm;
compute a system password by using the selected algorithm and the at least one system character;
accept a user entry;
compare the user entry with the system password;
grant access when the user entry is identical to the system password;
generate and display at least one hoax character.

It will be apparent that various other modifications and adaptations of the application will be apparent to the person skilled in the art after reading the foregoing disclosure without departing from the spirit and scope of the application and it is intended that all such modifications and adaptations come within the scope of the appended claims.

In the application, unless specified otherwise, the terms “comprising”, “comprise”, and grammatical variants thereof, are intended to represent “open” or “inclusive” language such that they include recited elements but also permit inclusion of additional, non-explicitly recited elements.

1. A computing system comprising:
memory for storing a user list, character configuration options, algorithm options, and a user registration system; and
at least one processor coupled to the memory and configured to execute the user registration system;
wherein the user registration system is configured to:
receive a login request from a user, the login request including a user ID;
look up the user in the user list to identify a selected character configuration from the character configuration options associated with the user ID and a selected password algorithm from the algorithm options associated with the user ID;
randomly generate at least one system character based on the selected character configuration;
transmit the at least one system character to the user for display based on the selected character configuration;
generate a system password based on the at least one system character and the selected password algorithm;
receive a user password from the user;
compare the system password and the user password; and
grant the user access to the computing system when the system password and the user password are the same.

2. The computing system of claim 1 wherein the user registration system is further configured to generate and display at least one hoax character, wherein the at least one hoax character is not used in generating the system password.

3. The computing system of claim 1, wherein the selected character configuration determines the positions the system characters will occupy when being displayed.

4. The computing system of claim 1, wherein the selected character configuration determines the sequence of appearance of the system characters.

5. The computing system of claim 1, wherein the selected password algorithm is selected from a group consisting of a mathematical equation and a string of characters.

6. The computing system of claim 1, wherein the at least one system character comprises one or more characters selected from a group consisting of alphabetic, numeric, alphanumeric, symbol, and punctuation characters.

7. A password authentication method for determining if access is to be granted to a computer system at a login stage comprising the steps of:
accepting a user name at a login screen;
associating the user name with a selected algorithm and a selected character configuration, the algorithm and the character configuration having been selected prior to the login stage;
randomly generating at least one system character based on the selected character configuration;
displaying the at least one system character according to the selected character configuration;
computing a system password by using the selected algorithm and the at least one system character;
accepting a user entry;
comparing the user entry with the system password; and
granting access when the user entry is identical to the system password.

8. The method of claim 7 further comprising the steps of randomly generating at least one hoax character and displaying the at least one hoax character, wherein the at least one hoax character is not used to compute the system password.

9. The method of claim 7, wherein the selected character configuration determines the positions the system characters will occupy when being displayed.

10. The method of claim 7, wherein the selected character configuration determines the sequence of appearance of the system characters.

11. The method of claim 7, wherein the selected algorithm is selected from a group consisting of a mathematical equation and a string of characters.

12. The method of claim 7, wherein the at least one system character comprises one or more characters selected from a group consisting of alphabetic, numeric, alphanumeric, symbol, and punctuation characters.
